(19) United States
(12) Patent Application Publication
(10) Pub. No.: US 2007/0212442 A1
(43) Pub. Date: Sep. 13, 2007

(54) Blow Mode Shell With Volume Insert System For A Blowing Machine

(76) Inventor: Osmar K. Nonogaki, Sao Paulo (BR)

Correspondence Address: Bliss McGlynn, 2075 West Big Beaver Road, Suite 600, Troy, MI, 48084, US

(21) Appl. No.: 10/577,750

(22) PCT Filed: Nov. 4, 2003
(86) PCT No.: PCT/BR03/00156

§ 371 Date: Jan. 8, 2007

(51) Int. Cl. B29C 49/28

(52) U.S. Cl. 425/541; 425/522

(57) ABSTRACT

The present invention describes a blow mold shell (M) of tubular shape, divided in both the longitudinal and transversal direction into individual parts (M1, M2, M3, M4, M5, M6) or divided in the longitudinal direction into individual parts (MF1 and MF2), each one of said parts featuring a cylindrical shell shape; parts (M1), (M3) and (M5) are supplementary, as well as parts (M2), (M4) and (M6); the supplementary parts are attached to each other by means of screws (P1); on the longitudinal ends of the supplementary parts there are calibrated grooves (E1 and E2) of rectangular profile which purpose is to ensure the alignment in the longitudinal axis; on parts (MF1) and (MF2) there are calibrated grooves onto which are assembled the form inserts (IF1, IF2 and IF3) also calibrated; between the supplementary parts of mold (M) there is a locking device made up of pegs (C, CF and CR), which are hidden inside cavities featured on mold parts (M) and attached to it by means of screws (P2 and P3); said locking device is responsible for preventing rotation between said parts as well as allowing its removal or replacement.

The present invention discloses the constructive form of a shell mold for blowing and stretching, equipped with a volume insert that allows variation of both volume and form of the molded product. The shell mold system with volume/form insert features a constructive disposition which generates savings in time to assemble the volume/form insert, as well as reducing the costs associated to the construction, because it is possible to produce different products using one and the same shell mold for blowing and stretching.

### BACKGROUND OF THE INVENTION

The blow and stretch machines allow production of plastic containers, among which one can mention bottles for carbonated beverages, non-carbonated beverages, pasteurized beverages, semi-solid food, wide opening recipients, as well as a vast series of containers for soft-drinks, water, sauces, detergent, juices, etc. In the machines of the current state of the art, a pair of shell holders is attached inside a pair of clamp brackets which purpose is to interconnect with the structure of the blowing machine which features articulated movement. The mold shell itself is composed by several parts that in turn are attached to the shell support. Said mold defines the shape of the container, that is, the mold cavity defines the product obtained in the blowing machine. The blow-stretch process involves the positioning of a heated preform inside the mold, being said preform attached to the mold by the neck and thread region. Once the mold is closed, that is, once the parts which make up the mold are assembled, a rod is introduced inside the preform promoting an axial stretch, later on pressure is injected, forcing the preform material to fully assume the shape of the mold including every detail. The assembly clamp brackets, shell mold holder/molds features a complex of channels/holes, designed to allow the flow of cooling water, allowing the temperature adjustment of the internal surface of the shell mold and the mold. Production of different products entails the drawback of demanding the construction of specific clamp brackets, shell mold holder and molds, which in turn generate high costs and costly installation and preparation routines. The preset invention allows a flexibilization of both the shape and volume of the products without demanding changes in the clamp brackets and shell mold holder, therefore leading to a remarkable reduction of the construction costs and time required to prepare the equipment.

### PURPOSE OF THE INVENTION

The object of the preset invention is to provide a blow mold shell with volume insert which allows for variation of the shape and/or volume of the molded product without requiring the replacement of the clamp brackets, shell mold holder and mold assembly. Said object is realized by means of the division of a mold into interchangeable parts, with engagement channels configured in the area between said parts, making possible quick changes of the molded product and furthermore reducing production costs.

### BRIEF DESCRIPTION OF THE DRAWINGS

The preset invention will be briefly described based on an incorporation example that is depicted in the drawings. The Figures are:

FIG. 1—a exploded perspective view of a mold with volume insert according to the present invention;

FIG. 2—a lateral view of the mold with volume insert;

FIG. 3—a front view of one of the halves of the mold with volume insert, with its parts assembled;

FIG. 4—an exploded perspective view of one of the halves of the mold with volume insert, with an enlarged detailing view of a locking system which equips said mold;

FIG. 5—a perspective view, in cross section, of one of the halves of the mold with volume insert, illustrating the attachment system of the parts, including also an enlarged detailed view of a locking system that equips said mold.

FIG. 6—a perspective view of a mold with form insert according to the present invention;

FIG. 7—an exploded perspective view of one of the halves of the mold with form insert;

FIG. 8—a front view of one of the halves of the mold with form insert, with its component parts assembled and illustrated in an enlarged detailed view of a locking system employed in said mold;

FIG. 9—a perspective view of a mold with form insert being assembled/disassembled.

### DETAILED DESCRIPTION OF THE INVENTION

The present invention eliminates the drawbacks of the present state of the art by means of the division of said mold into interchangeable parts, featuring engagement slits in the area between said parts. Along with attachment screws, said slits make possible the assembly of the mold.

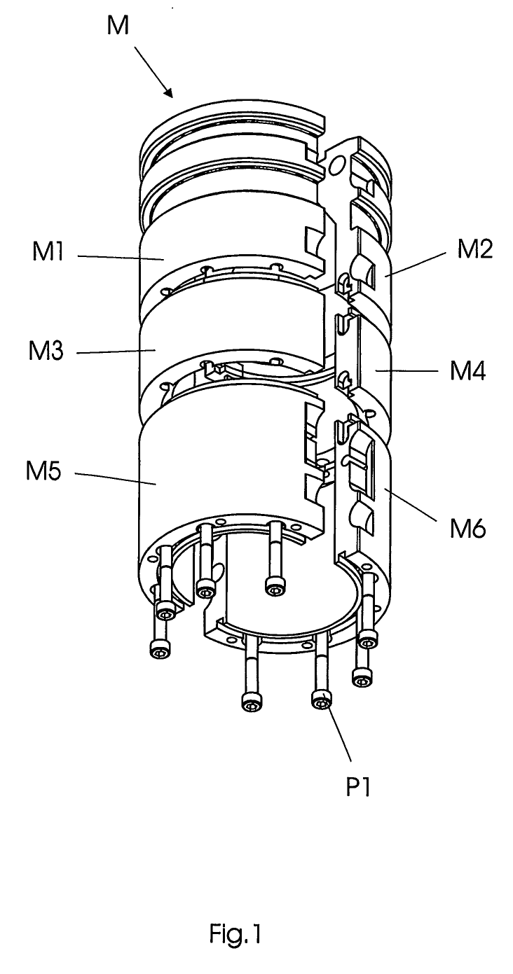

FIG. 1 shows an exploded perspective view of a mold M with volume insert according to the present invention, having said mold a tube shape symmetrically divided in the longitudinal axis and also symmetrically divided in the transversal axis, originating parts M1, M2, M3, M4, M5, M6; parts M1, M3 and M5 are coupled to each other by means of screws P1, as well as parts M2, M4 and M6.

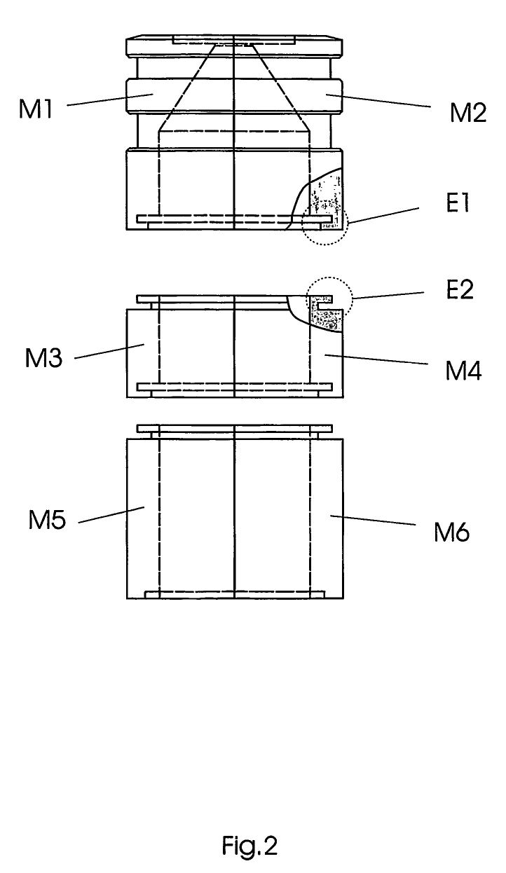

FIG. 2 exhibits parts M1 and M2, M3 and M4, M5 and M6 diametrically coupled and longitudinally separated, and also presents sections of the region of engagement between parts M2 and M4; the base of part M2 presents a channel E1 (indicated by an encircling dashed line) of rectangular profile with dimensions similar equivalent to those of channel E2 (indicated by an encircling dashed line) however presenting on the top part of part M4 channels E1 and E2 which are geometrically opposed so as to ensure the alignment in the longitudinal axis; the same profile observed in the engagement region between parts M2 and M4 occurs between parts M4 and M6, M1 and M3 and finally between M3 and M5.

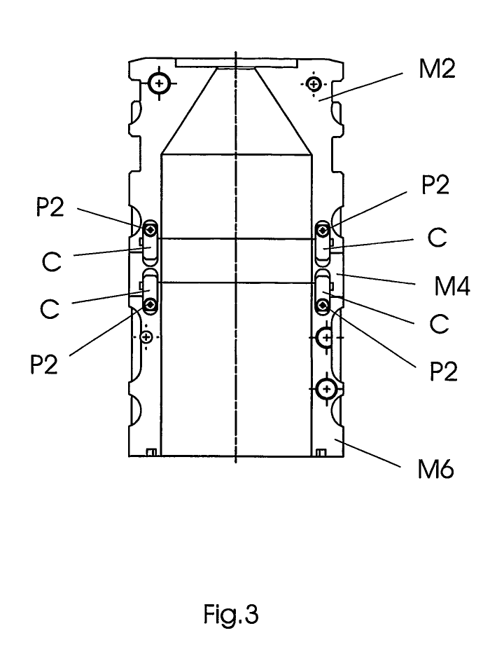

FIG. 3 illustrates a front view of one of the halves of the mold with volume insert, with its constituting parts assembled, illustrating the inside of the mold and a locking system between parts of mold M, being said locking system made up by alignment pegs C formed by rectangular blocks, set inside channels of elongated shape positioned on the contact surface between the symmetrically opposed parts and at the intersection between parts M2 and M4, M4 and M6, M1 and M3, M3 and M5;

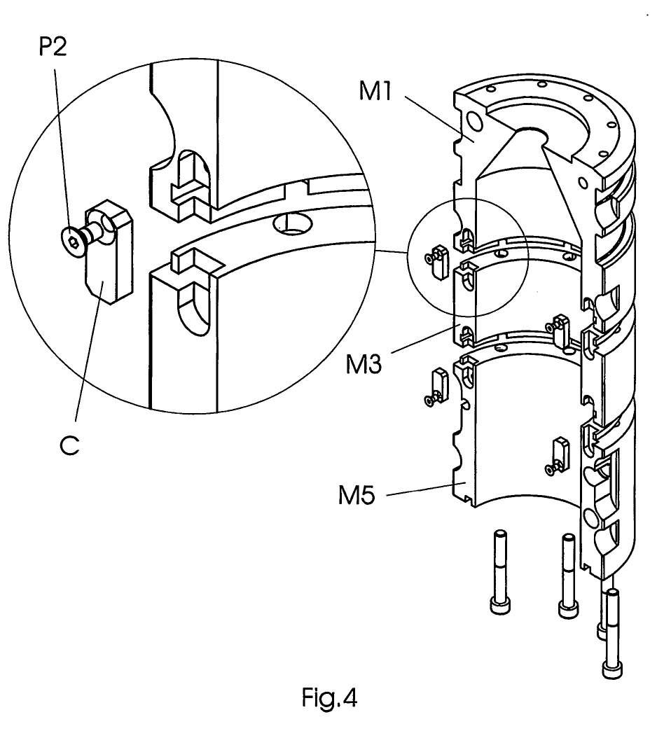

FIG. 4 presents an exploded perspective view of one of the halves of the mold with volume insert, with an enlarged detailing view of the locking device used on said mold M; the alignment pegs C feature in one of its ends a cavity which purpose is to accommodate the head of the screw P2, by means of which said pegs are attached to parts M1, M2, M5 and M6. Said locking device is responsible for preventing rotation between the constituting parts of the mold M.

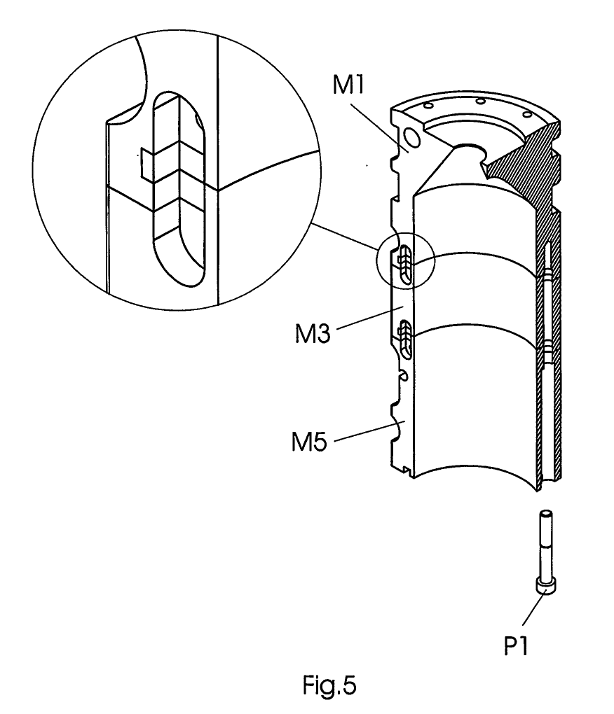

FIG. 5 shows a perspective view of one of the halves of the mold with volume insert assembled; a longitudinal section shows the channels that accommodate the attachment screws P between parts M1, M3 and M5; an enlarged detailing view illustrates an elongated shape channel, positioned between parts M1 and M3, which houses the alignment peg C.

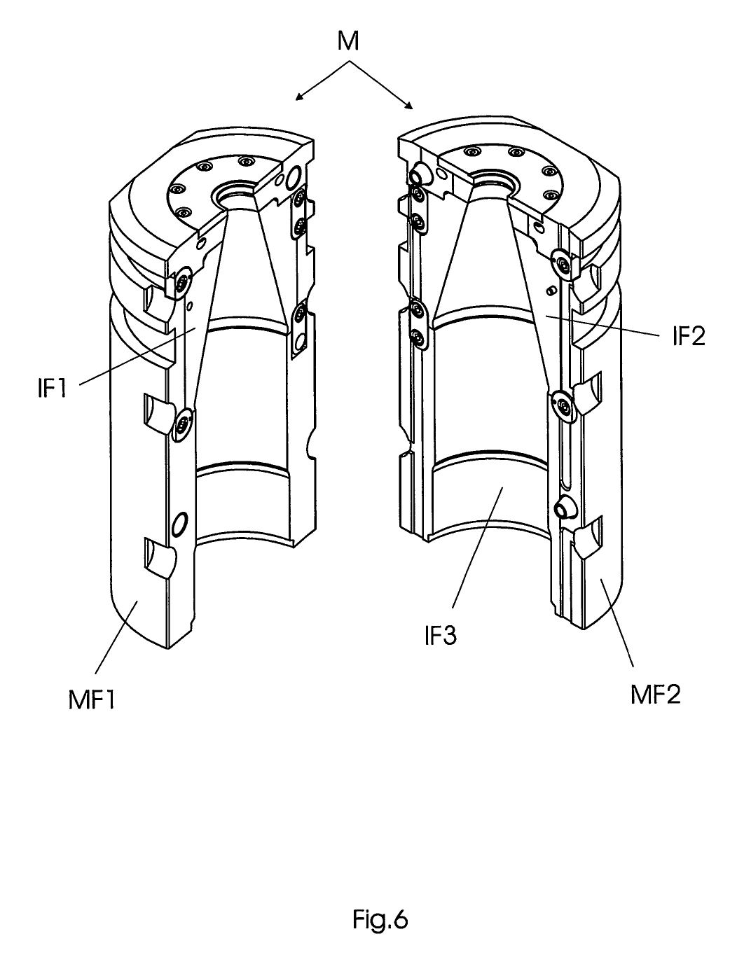

FIG. 6 illustrates a perspective view of a mold M with form insert according to the present invention, with a tube shape symmetrically divided in the longitudinal axis, originating parts MF1 and MF2 symmetrically opposed; part MF1 lodges volume insert IF1 and part MF2 lodges volume inserts IF2 and IF3.

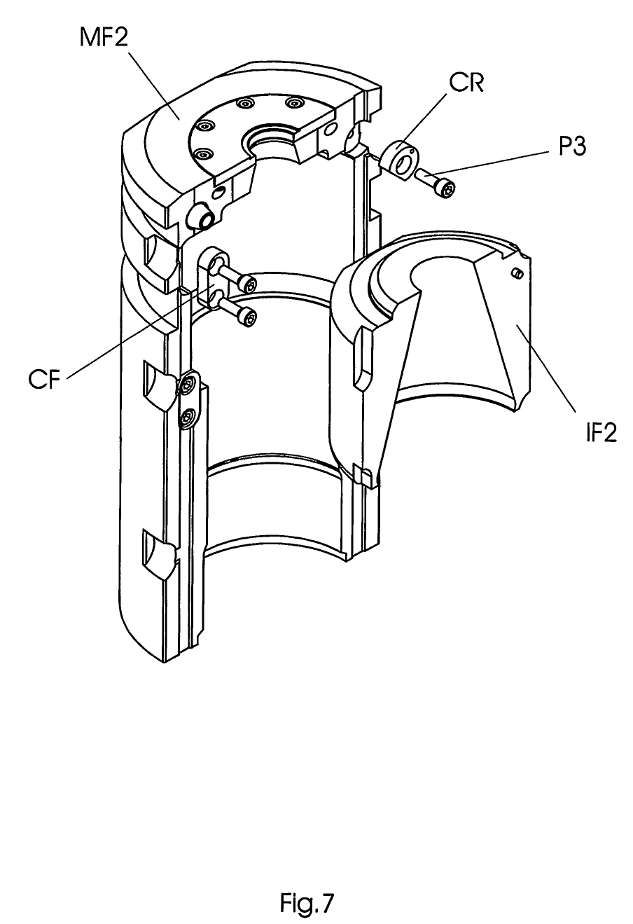

FIG. 7 illustrates an exploded perspective view of part MF2 of mold M, with volume insert IF2 out of its lodge and a locking system made up of fixed pegs CF and rotating pegs CR; the fixed pegs CF are made up of rectangular blocks with rounded ends, and around said ends are placed cavities which purpose is to lodge the heads of the P3 screws, said screws being responsible for attaching said pegs to the mold parts M; the rotating pegs CR are of cylindrical shape with a lateral groove. The center of the rotating pegs CR features a cavity which purpose is to lodge the head of screw P3, by means of which the pegs CR are attached to the mold parts M.

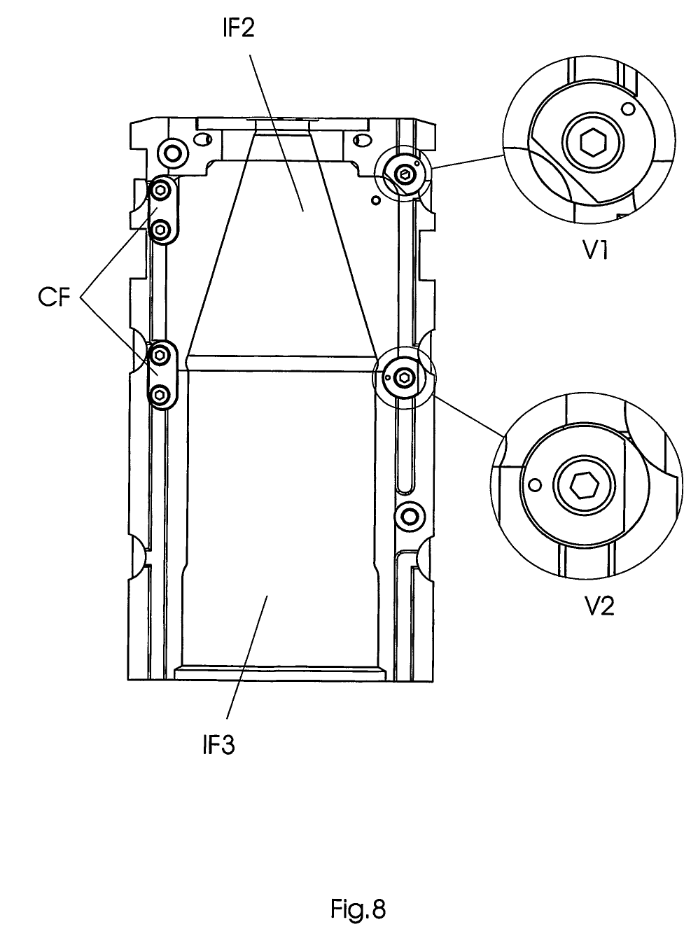

FIG. 8 illustrates a front view of part MF2, with its component parts assembled, showing the inside of the mold and the locking system between part MF2 and form inserts IF2 and IF3; fixed pegs CF are lodged in elongated shape channels and rotating pegs CR are lodged into circular channels, being both channels set on the contact surface between parts MF1 and MF2; two detailed views V1 and V2 are presented illustrating enlarged details of the locking system made up of rotating pegs CR; V1 view features a turned CR peg, so as to allow the removal of said insert IF2; view V2 features a turned CR peg, so as to prevent the removal of inserts IF2 and IF3.

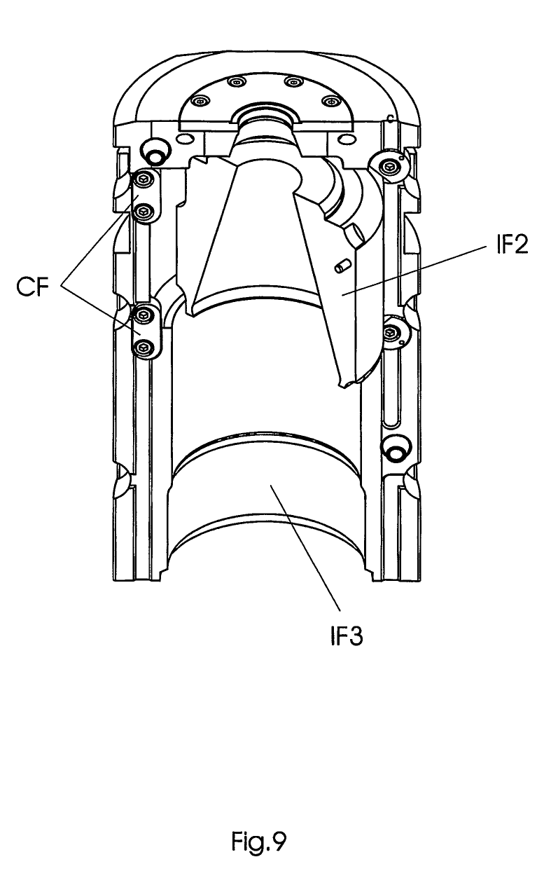

FIG. 9 illustrates a perspective view of part M2 of mold M, with rotating pegs CR rotated and thus allowing the assembly/disassembly of the form inserts with no need to remove fixed pegs CF.

The above description makes evident that the advantage of the present mold M lies in the fact that a simple substitution or removal of parts and inserts allows manufacture of different products, regarding both form and volume. Said advantage is of remarkable importance from the economic point of view because there is no need to use several different molds for each product of different volume/form.

Although a preferential incorporation example has been described, it must be understood that the scope of the preset invention encompasses other possible variations, being limited only by the contents of the following set of claims, including the possible equivalents.

What is claimed is:

1) “BLOW MOLD SHELL WITH VOLUME INSERT SYSTEM FOR BLOWING MACHINE” characterized by the fact that it comprises a blow mold shell (M) of tubular shape, divided in the longitudinal direction into individual parts (MF1 and MF2), each one of said parts having the shape of a cylindrical shell.

2) “BLOW MOLD SHELL”, according to claim 1, characterized by the fact that the parts (MF1 and MF2) are divided in the transversal direction into individual parts (M1, M2, M3, M4, M5, M6); parts (M1), (M3) and (M5) are supplementary, as well as parts (M2), (M4) and (M6); the supplementary parts are attached to each other by means of screws (P1); on the longitudinal ends of the supplementary parts there are calibrated grooves (E1 and E2) of rectangular profile; there is also a locking device set between the supplementary parts of mold (M).

3) “BLOW MOLD SHELL”, according to claims 1 and 2, characterized by the fact that the calibrated grooves (E1 and E2) of the longitudinal ends of the supplementary parts of mold (M) have a rectangular profile, being geometrically opposed to each other.

4) “BLOW MOLD SHELL”, according to claims 1 and 2, characterized by the fact that the locking device is made up of pegs (C) hidden inside cavities of elongated shape positioned on parts of mold (M); pegs (C) are attached to parts of mold (M) by means of screws (P2).

5) “BLOW MOLD SHELL”, according to claims 1 and 2, characterized by the fact that parts M3 and M4 are removable or replaceable.

6) “BLOW MOLD SHELL”, according to claim 1, characterized by the fact that parts (MF1 and MF2) feature calibrated grooves to which are assembled form inserts (IF1, IF2 and IF3) also calibrated; between parts (MF1) and (MF2) and the forms inserts (IF1), (IF2) and (IF3) there is a locking device.

7) “BLOW MOLD SHELL”, according to claim 1, characterized by the fact that the locking device is made up of fixed pegs (CF) embedded in elongated shape cavities set on the mold parts (M); the fixed pegs (CF) are attached to the mold parts (M) by means of screws (P3).

8) “BLOW MOLD SHELL”, according to claim 1, characterized by the fact that the locking device is made up of rotating pegs (CR) embedded in circular shape cavities set on the mold parts (M); the rotating pegs (CR) are attached to the mold parts (M) by means of screws (P3); the rotating pegs (CR) allow the assembly or removal of the form inserts (IF1, IF2 and IF3) without the need to completely remove said pegs.

9) “BLOW MOLD SHELL”, according to claim 1, characterized by the fact that the form inserts (IF1, IF2 and IF3) are replaceable.
